(19) United States
(12) Patent Application Publication
(10) Pub. No.: US 2026/0278866 A1
(43) Pub. Date: Sep. 17, 2026

(54) DISPLAY SYSTEM

(71) Applicant: TOYOTA JIDOSHA KABUSHIKI KAISHA, Toyota-shi (JP)

(72) Inventor: Kazuho SAEKI, Kawasaki-shi (JP)

(73) Assignee: TOYOTA JIDOSHA KABUSHIKI KAISHA, Toyota-shi (JP)

(21) Appl. No.: 19/439,027

(22) Filed: Jan. 2, 2026

(30) Foreign Application Priority Data
Mar. 12, 2025 (JP) 2025-039670

(51) Int. Cl. G06T 11/26; G06T 11/60

(52) U.S. Cl. CPC G06T 11/26; G06T 11/60

(57) ABSTRACT

A display system according to the present disclosure includes a physical property value estimation unit and a display controller. The physical property value estimation unit estimates a physical property value of a simulated sample having a feature amount set by a user. The display controller displays, in the same screen, an image representing a magnitude of the feature amount set by the user and an image representing a magnitude of the estimated physical property value.

### CROSS-REFERENCE TO RELATED APPLICATION

This application claims priority to Japanese Patent Application No. 2025-039670 filed on Mar. 12, 2025. The disclosure of the above-identified application, including the specification, drawings, and claims, is incorporated by reference herein in its entirety.

### BACKGROUND

### 1. Technical Field

The present disclosure relates to a display system.

### 2. Description of Related Art

Japanese Unexamined Patent Application Publication No. 2024-073299 (JP 2024-073299 A) discloses an information processing apparatus.

The information processing apparatus disclosed in JP 2024-073299 A generates two-dimensional map data in which each of a plurality of pieces of spectral data is projected onto two dimensions as each of a plurality of plot points by applying principal component analysis. Then, the information processing apparatus disclosed in JP 2024-073299 A specifies unknown data representing a plot point different from the plot point already present on the two-dimensional map data, and executes an operation of converting the unknown data into the spectral data.

### SUMMARY

Meanwhile, in a case of performing material development based on analysis using a feature amount, there is a necessity for understanding a correlation between the feature amount and a physical property value of a development material.

In response to such a problem, JP 2024-073299 A discloses executing regression analysis between a principal component score (value of each of the dimensions) and a performance value of a material.

However, there is a difficulty in interpreting a result of the regression analysis, and a user may not be able to easily understand the analysis result unless the user relies on an experience rule of a skilled researcher. That is, in the technique disclosed in JP 2024-073299 A, there is room for improvement in terms of enabling the user to easily understand the correlation between the principal component score, which is the result of the principal component analysis, and the physical property of the development material.

The present disclosure has been made to solve such a problem, and an object thereof is to provide a display system capable of enabling a user to more easily understand a correlation between a feature amount and a physical property value.

A display system according to the present disclosure includes
a physical property value estimation unit and a display controller. The physical property value estimation unit estimates a physical property value of a simulated sample having a feature amount set by a user.
   The display controller displays, in the same screen, an image representing a magnitude of the feature amount set by the user and an image representing a magnitude of the estimated physical property value.

The display system according to the present disclosure may further include
a reconstruction data output unit that outputs reconstruction data that is data obtained by simulating measurement data obtained in a case where the simulated sample is measured.
   In the display system according to the present disclosure, the display controller may further display an image representing the reconstruction data in the screen on which the image representing the magnitude of the feature amount set by the user and the image representing the magnitude of the estimated physical property value are displayed.

The display system according to the present disclosure may further include
a data editor that receives editing of the reconstruction data from the user, and
a feature amount extraction unit that extracts the feature amount from the edited reconstruction data.
   In the display system according to the present disclosure, the physical property value estimation unit may estimate the physical property value of the simulated sample having the feature amount extracted from the edited reconstruction data.

The display system according to the present disclosure may further include
a measurement data acquisition unit that acquires a plurality of pieces of measurement data of samples.
   In the display system according to the present disclosure, the display controller may
display a selection image for the user to select each of the feature amounts in a vicinity of the image representing the magnitude of the feature amount, and
further display, in the screen, a mapping image in which the acquired plurality of pieces of measurement data are mapped with a feature amount selected by the selection image as a graph axis.

The display system according to the present disclosure may further include
a measurement data acquisition unit that acquires a plurality of pieces of measurement data of samples,
an outlier determination unit that determines whether the set feature amount corresponds to an outlier in a data group including the acquired plurality of pieces of measurement data of samples, and
a notification unit that notifies the user of a warning in a case where the outlier determination unit determines that the set feature amount corresponds to the outlier.

According to the present disclosure, it is possible to provide a display system capable of enabling a user to more easily understand a correlation between a feature amount and a physical property value.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of an analysis system according to a first embodiment;

FIG. 2 is a block diagram showing a configuration of a server according to the first embodiment;

FIG. 3 is a block diagram showing a configuration of the server according to the first embodiment;

FIG. 4 is a schematic screen diagram for describing a display controller according to the first embodiment;

FIG. 5 is a flowchart showing a display method according to the first embodiment;

FIG. 6 is a block diagram showing a configuration of a server according to a second embodiment; and

FIG. 7 is a schematic screen diagram showing a configuration of a display controller according to another embodiment.

### DETAILED DESCRIPTION OF EMBODIMENTS

### First Embodiment

### Configuration of Display System

Hereinafter, a first embodiment according to the present disclosure will be described in detail with reference to the drawings. First, a configuration of the display system according to the present embodiment will be described in detail.

The display system according to the present embodiment is configured as a part of an analysis system according to the present embodiment. More specifically, the display system according to the present embodiment is used to display an analysis result of the analysis system according to the present embodiment to the user.

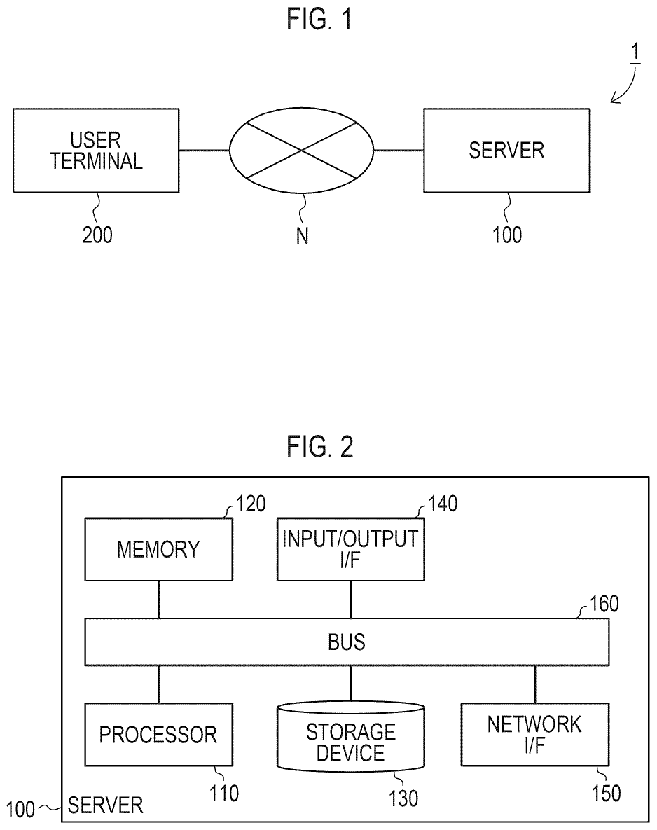

FIG. 1 is a block diagram showing a configuration of the analysis system according to the first embodiment. As shown in FIG. 1, in an analysis system 1 according to the present embodiment, a server 100 and a user terminal 200 are connected to each other via a network N such as the Internet.

The analysis system 1 is a system for analyzing measurement data obtained by actually measuring a sample and physical property value data. The analysis system 1 according to the present embodiment is typically provided as a part of a data cloud type service used for material development or research and development. The analysis system 1 according to the present embodiment is used as a system for promoting so-called materials informatics (MI) or research and development using data science.

In the analysis system 1, the user terminal 200 transmits the measurement data to the server 100, and the server 100 analyzes the received measurement data. Then, the server 100 transmits the analysis result to the user terminal 200, and the user terminal 200 displays the received analysis result to the user.

Examples of the measurement data analyzed by the analysis system 1 include spectral data, waveform data, graph data, two-dimensional image data, and three-dimensional image data.

Examples of the spectral data include spectral data measured by using nuclear magnetic resonance spectroscopy (NMR), infrared spectroscopy (IR), ultraviolet-visible spectroscopy (UV-vis), X-ray absorption spectroscopy (XAS), Raman spectroscopy, X-ray diffraction (XRD), small-angle X-ray scattering (SAXS), and mass spectrometry (MS).
In addition, examples of the two-dimensional image data include image data captured by using an optical microscope, a scanning electron microscope (SEM), a transmission electron microscope (TEM), or computed tomography (CT).
In addition, examples of the three-dimensional image data include captured data created by laminating tomographic images captured by computed tomography (CT). In addition, examples thereof include model data created by computer-aided design (CAD) or the like.
In addition, examples of the waveform data include time-series data and displacement data. Examples of the time-series data include acoustic data and vibration data, but any data in which a numerical value changes with a change in time can be used as the time-series data. Examples of the displacement data include a surface height of a sample and a surface profile, but any data in which a numerical value changes with a change in coordinates and other parameters can be used as the displacement data.
In addition, examples of the other data include a cyclic voltammogram and a gas chromatography (GC) chart graph.
Further, as the measurement data, for example, coordinate data such as a crystallographic information (CIF) file and numerical data such as a component table of a composition can also be used.

In addition, examples of the physical property value analyzed by the analysis system 1 include a mechanical physical property value, a physical physical property value, and a chemical physical property value.

Examples of the mechanical physical property value include strength, hardness, toughness, and abrasion resistance. Examples of the physical physical property value include density, conductivity, magnetism, thermal conductivity, and thermal expansion coefficient. Examples of the chemical physical property value include corrosion resistance.

Although the details will be described later, the display system according to the present embodiment estimates the physical property value of a virtual sample, that is, the physical property value of the simulated sample based on the feature amount extracted from the measurement data. Then, the display system according to the present embodiment displays an image representing the magnitude of the estimated physical property value to the user. Therefore, the physical property value according to the present embodiment is preferably a physical property value having a correlation with the feature amount extracted from the measurement data.

The user terminal 200 according to the present embodiment is a terminal operated by the user, and is typically a computer device having a display device.

The user terminal 200 transmits the measurement data and the physical property value to the server 100 via the network N. Then, the user terminal 200 receives the analysis result of the measurement data from the server 100 via the network N.

The server 100 according to the present embodiment receives the measurement data and the physical property value data from the user terminal 200, and analyzes the received measurement data and physical property value data. Then, the server 100 transmits the analysis result to the user terminal 200 via the network N.

FIG. 2 is a block diagram showing a hardware configuration of the server according to the first embodiment.

As shown in FIG. 2, the server 100 includes a processor 110, a memory 120, a storage device 130, an input/output interface 140, a network interface 150, and an internal bus 160.

The internal bus 160 is a data transmission path for the processor 110, the memory 120, the storage device 130, the input/output interface 140, and the network interface 150 to transmit and receive data to and from each other. However, a method of connecting the processor 110 and the like to each other is not limited to the bus connection.

The memory 120 is a main storage device implemented by using a random access memory (RAM) or the like.

In addition, the storage device 130 is an auxiliary storage device implemented by using a hard disk, a solid state drive (SSD), a memory card, a read only memory (ROM), or the like. The storage device 130 stores a program for implementing a desired function.

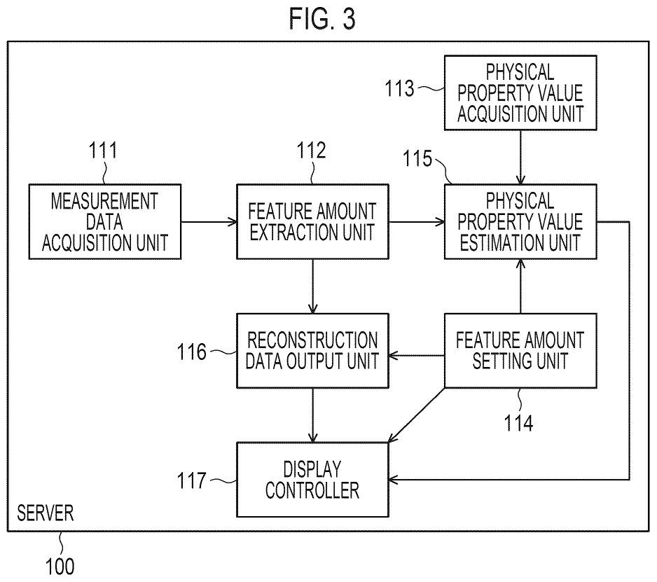

The processor 110 is various processors such as a central processing unit (CPU), a graphics processing unit (GPU), and a field-programmable gate array (FPGA). The processor 110 executes a function as each of functional blocks shown in FIG. 3, which will be described later, by reading out and executing the program stored in the storage device 130 into the memory 120.

The input/output interface 140 is an interface for connecting the server 100 and an input/output device. For example, an input device such as a keyboard or an output device such as a display device may be connected to the input/output interface 140.

The network interface 150 is an interface for connecting the server 100 to the network.

The program includes an instruction set (or a software code) that causes the computer to perform one or more functions described in the embodiment in a case where the program is read into the computer. The program may be stored in a non-transitory computer-readable medium or a tangible storage medium. Examples of the computer-readable medium or the tangible storage medium include a RAM, a ROM, a flash memory, an SSD, or other memory technologies, a CD-ROM, a digital versatile disc (DVD), a Blu-ray (registered trademark) disc, or other optical disc storages, a magnetic cassette, a magnetic tape, a magnetic disk storage, or other magnetic storage devices, but not limited thereto. The program may be transmitted on a transitory computer-readable medium or a communication medium. Examples of the transitory computer-readable medium or the communication medium include electrical, optical, acoustic, or other forms of propagating signals, but not limited thereto.

FIG. 3 is a block diagram showing functions of the server 100 according to the first embodiment.

As shown in FIG. 3, the server 100 according to the present embodiment includes a measurement data acquisition unit 111, a feature amount extraction unit 112, a physical property value acquisition unit 113, a feature amount setting unit 114, a physical property value estimation unit 115, a reconstruction data output unit 116, and a display controller 117 as functional blocks.

The measurement data acquisition unit 111 acquires a plurality of pieces of measurement data of samples. More specifically, the measurement data acquisition unit 111 according to the present embodiment acquires the pieces of measurement data from the user terminal 200 via the network N. The measurement data acquisition unit 111 outputs the acquired plurality of pieces of measurement data to the feature amount extraction unit 112.

The measurement data acquisition unit 111 according to the present embodiment does not need to acquire the pieces of measurement data by receiving the pieces of measurement data at once.

For example, the measurement data acquisition unit 111 according to the present embodiment may acquire the pieces of measurement data by acquiring the measurement data a plurality of times.

In this case, the measurement data acquisition unit 111 may store the acquired measurement data in the storage device 130 each time the measurement data is acquired. Then, the feature amount extraction unit 112 may appropriately read out the measurement data to be analyzed from the storage device 130.

That is, the measurement data acquisition unit 111 may create a database in which the measurement data is recorded. Then, the created database may be configured such that the user can appropriately select the measurement data to be analyzed.

The database may record not only the measurement data of each of the samples but also identification information, the physical property value, the experimental information, the extracted feature amount, and a comment from the user of each of the samples.

That is, the database may be a database in which various types of data are recorded in association with each sample. The analysis system and the display system according to the present embodiment may be configured to be able to appropriately read out and use the information recorded in the database.

The feature amount extraction unit 112 acquires the pieces of measurement data from the measurement data acquisition unit 111. The feature amount extraction unit 112 extracts the feature amount from the acquired plurality of pieces of measurement data. The feature amount extraction unit 112 outputs the extracted feature amount to the physical property value estimation unit 115 and the reconstruction data output unit 116.

The feature amount extraction unit 112 may store the extracted feature amount in the database. Then, the physical property value estimation unit 115 and the reconstruction data output unit 116 may appropriately read out and use the feature amount recorded in the database.

Specifically, the feature amount extraction unit 112 according to the present embodiment executes principal component analysis (PCA) on a plurality of pieces of analysis target data. As a result, the feature amount extraction unit 112 acquires a principal component and a principal component score as the feature amount. The principal component and the principal component score obtained by the principal component analysis are particularly difficult for the user to intuitively understand among the results obtained by the analysis using the feature amount. Therefore, the display system according to the present disclosure has a particularly significant effect in a case where the principal component score is used as the feature amount.

However, the feature amount extracted from the measurement data by the feature amount extraction unit 112 is not limited to the principal component and the principal component score. The feature amount extracted from the measurement data by the feature amount extraction unit 112 may be any feature amount as long as the feature amount is related to the physical property value of the sample.

The physical property value acquisition unit 113 acquires a plurality of the physical property values of the samples. The physical property value acquisition unit 113 outputs the acquired physical property value to the physical property value estimation unit 115.

The physical property value acquisition unit 113 may store the acquired physical property value in the database. Then, the physical property value estimation unit 115 may appropriately read out and use the physical property value recorded in the database.

The feature amount setting unit 114 receives the setting of the feature amount from the user. The feature amount setting unit 114 outputs the feature amount set by the user to the physical property value estimation unit 115, the reconstruction data output unit 116, and the display controller 117.

The “setting of the feature amount” referred to here refers to the user setting the feature amount of a virtual sample that does not actually exist, that is, the simulated sample. That is, the “setting of the feature amount” referred to here may mean that the user defines the simulated sample.

The feature amount setting unit 114 may receive the setting of the feature amount from the user by receiving, for example, a specific numerical value.

In addition, although the details will be described later, the feature amount setting unit 114 may receive the setting of the feature amount from the user by receiving editing of an “image representing the magnitude of the feature amount set by the user” displayed by the display controller described later.

The physical property value estimation unit 115 acquires the feature amount extracted from the measurement data of the sample from the feature amount extraction unit 112, acquires the physical property value of the sample from the physical property value acquisition unit 113, and acquires the feature amount set by the user from the feature amount setting unit 114. However, the physical property value estimation unit 115 may read out the feature amount extracted from the measurement data of the sample, the physical property value of the sample, and the feature amount set by the user from the database.

Then, the physical property value estimation unit 115 estimates the physical property value of the simulated sample having the feature amount set by the user. The physical property value estimation unit 115 outputs the estimated physical property value of the simulated sample to the display controller 117.

As a specific example, the physical property value estimation unit 115 according to the present embodiment acquires a principal component score as the feature amount extracted from the measurement data of the sample, and acquires a principal component score set by the user as the feature amount set by the user.

The physical property value estimation unit 115 executes regression analysis on the acquired principal component score and the physical property value to estimate a correlation between the acquired principal component score and the physical property value. Then, the physical property value estimation unit 115 estimates the physical property value of the simulated sample having the principal component score set by the user by referring to the correlation between the estimated principal component score and the physical property value.

The reconstruction data output unit 116 acquires the feature amount extracted from the measurement data from the feature amount extraction unit 112 and acquires the feature amount set by the user from the feature amount setting unit 114. The reconstruction data output unit 116 outputs reconstruction data that is data obtained by simulating measurement data obtained in a case where the simulated sample is measured.

The reconstruction data output unit 116 may read out the principal component extracted from the measurement data from the database.

More specifically, the reconstruction data output unit 116 according to the present embodiment acquires the principal component from the feature amount extraction unit 112 and acquires the principal component score set by the user from the feature amount setting unit 114. Then, the reconstruction data output unit 116 outputs the reconstruction data based on the acquired principal component and the principal component score set by the user.

More specifically, the reconstruction data output unit 116 according to the present embodiment may acquire a vector representing the principal component from the first component to the n-th component. Then, the reconstruction data output unit 116 may calculate a vector D^{rec} according to Equation (1) and output the reconstruction data by converting the calculated vector D^{rec}.

$${D}^{rec} = {S}_{1} {v}_{1} + {S}_{2} {v}_{2} + … + {S}_{n} {v}_{n} \qquad Equation ( 1 )$$

where
Sₖ is a principal component score of the k-th component set by the user, and
vₖ is a vector representing the principal component of the k-th component.

By the method as described above, the reconstruction data output unit 116 can simulate the measurement data obtained in a case where the simulated sample is measured. However, the method of the reconstruction data output unit 116 for outputting the reconstruction data is not limited to the above. The reconstruction data output unit 116 may use any method to output the reconstruction data as long as the measurement data of the simulated sample defined by the user can be appropriately simulated.

The display controller 117 acquires the feature amount set by the user from the feature amount setting unit 114, acquires the estimated physical property value from the physical property value estimation unit 115, and acquires the output reconstruction data from the reconstruction data output unit 116.

The display controller 117 controls a screen displayed on the user terminal 200. More specifically, the display controller 117 controls a display screen of the user terminal 200 and displays an image representing the magnitude of the feature amount set by the user and an image representing the magnitude of the estimated physical property value in the same screen.

In addition, the display controller 117 controls the display screen of the user terminal 200, and further displays an image representing the reconstruction data in the screen on which the image representing the magnitude of the feature amount set by the user and the image representing the magnitude of the estimated physical property value are displayed.

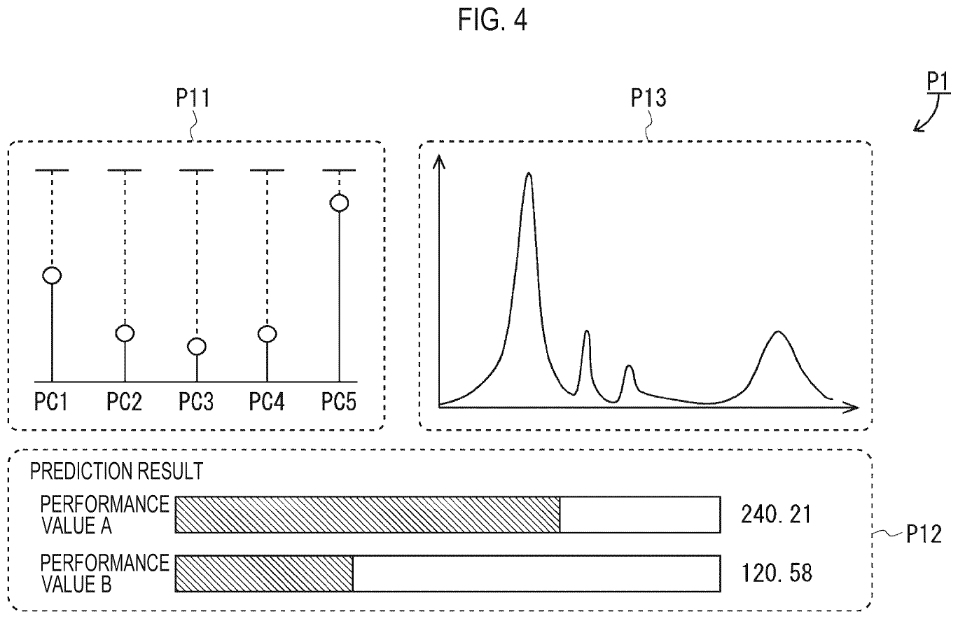

FIG. 4 is a schematic screen diagram for describing a configuration of the display controller 117 according to the first embodiment. More specifically, FIG. 4 is a schematic screen diagram showing an example of a screen displayed on the user terminal 200 by the display controller according to the first embodiment.

The display controller 117 according to the present embodiment controls the display screen of the user terminal 200 and displays a screen P1 as shown in FIG. 4. On the screen P1, an image P11 representing the magnitude of the feature amount set by the user, an image P12 representing the magnitude of the estimated physical property value, and an image P13 representing the reconstruction data are displayed.

The image P11 is an image representing the magnitude of the feature amount set by the user, and more specifically, is an image in which the magnitude of the feature amount set by the user is indicated by a bar.

As shown in FIG. 4, the image P11 according to the present embodiment indicates magnitudes of five types of feature amounts having identification names of PC1, PC2, PC3, PC4, and PC5 by the heights of the bars.

The image P11 according to the present embodiment is configured to be editable by the user operation. That is, in the present embodiment, the user can change the height of the bar displayed as the image P11 by operating the user terminal 200.

In a case where the height of the bar is changed by the user, the feature amount setting unit 114 receives the feature amount corresponding to the changed height of the bar as the feature amount set by the user.
That is, the image P11 according to the present embodiment may function as an image for receiving the setting of the feature amount from the user.

The display controller 117 according to the present embodiment may display an image representing the magnitude of the feature amount extracted from the measurement data of the actual sample as the image P11 in an editable manner. Then, the feature amount setting unit 114 may receive the setting of the feature amount from the user by receiving the editing of the image P11 from the user. With such a configuration, the user can define the simulated sample while referring to the actual sample.

The image P12 is an image representing the magnitude of the physical property value estimated by the physical property value estimation unit 115, and more specifically, is an image in which the magnitude of the estimated physical property value is indicated by a bar.

As shown in FIG. 4, the image P12 according to the present embodiment indicates magnitudes of two types of physical property values having identification names of a performance value A and a performance value B by the horizontal length of the bar.

As shown in FIG. 4, the image P12 representing the magnitude of the estimated physical property value is displayed together with the image P11 representing the magnitude of the feature amount set by the user.

With such a configuration, the user can visually sense the correlation between the feature amount and the physical property value, and as a result, can easily understand the correlation between the feature amount and the physical property value. In other words, with such a configuration, the display system according to the present embodiment can enable the user to more easily understand the correlation between the feature amount and the physical property value.
By understanding the correlation between the feature amount and the physical property value, the user can appropriately formulate a guideline for developing a sample having a desired performance, and as a result, can efficiently perform the development activity.

The image P13 is an image representing the reconstruction data output by the reconstruction data output unit 116, and in the present embodiment, as an example, a spectral image is displayed.

As shown in FIG. 4, the image P13 representing the reconstruction data is displayed in the same screen as the image P11 and the image P12.
With such a configuration, the user can easily understand what feature of the measurement data is represented by the feature amount. Further, with such a configuration, the user can easily understand the correlation between the feature of the measurement data and the physical property value.
By understanding the correlation between the feature of the measurement data and the physical property value, the user can further specifically formulate a guideline for developing a sample having a desired performance. As a result, the development activity can be performed more efficiently.

The display controller 117 according to the present embodiment may display the image P11, the image P12, and the image P13 to change in conjunction with each other. That is, in a case where the image P11 continuously changes by the user operation, the display controller 117 may continuously change the image P12 and the image P13.

With such a configuration, the user can more accurately understand the correlation between the feature amount, the physical property value, and the measurement data.

As described above, the display system according to the present embodiment displays the image P11 representing the magnitude of the feature amount set by the user, the image P12 representing the magnitude of the estimated physical property value, and the image P13 representing the reconstruction data in the same screen.

With such a configuration, the display system according to the present embodiment can enable the user to more easily understand the correlation between the feature amount and the physical property value. In addition, with such a configuration, the display system according to the present embodiment can enable the user to more easily understand the correlation between the measurement data and the physical property value.

Further, the display system according to the present embodiment may display the image P11 representing the magnitude of the feature amount set by the user, the image P12 representing the magnitude of the estimated physical property value, and the image P13 representing the reconstruction data to change in conjunction with each other.

With such a configuration, the display system according to the present embodiment can enable the user to more easily understand the correlation between the feature amount, the physical property value, and the measurement data.

### Operation of Display System

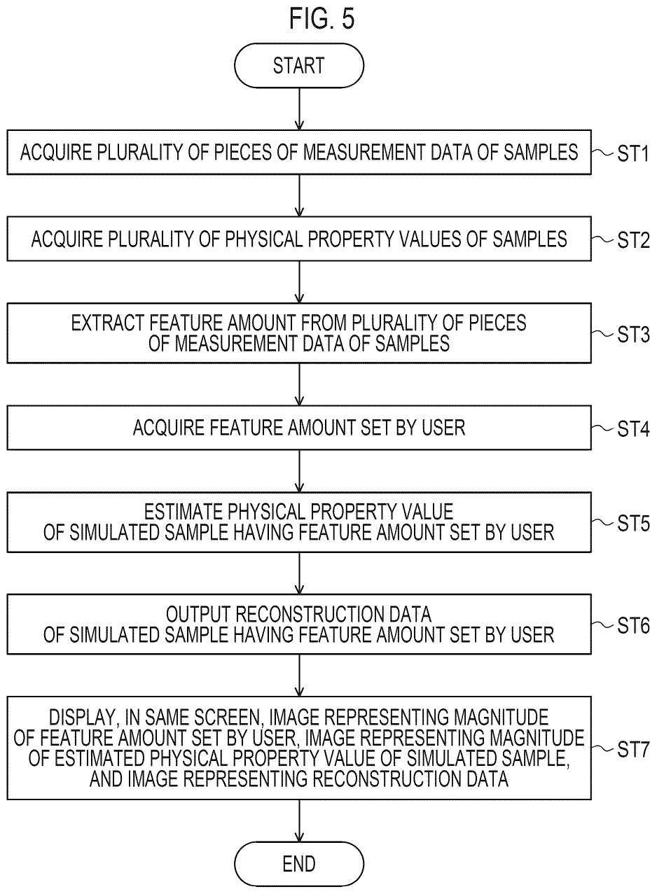

Subsequently, the operation of the display system, that is, the display method according to the first embodiment will be described in detail. FIG. 5 is a flowchart showing an operation of the display system according to the first embodiment. In the following description, FIGS. 1 to 4 will be appropriately referred to.

In the processing procedure of FIG. 5, the processor 110 reads out and executes the program stored in the storage device 130 into the memory 120. As a result, the processor 110 functions as the measurement data acquisition unit 111, the feature amount extraction unit 112, the physical property value acquisition unit 113, the feature amount setting unit 114, the physical property value estimation unit 115, the reconstruction data output unit 116, and the display controller 117.

In the display method according to the present embodiment, first, the processor 110 acquires the pieces of measurement data of the samples (ST1). That is, in ST1, the processor 110 functions as the measurement data acquisition unit 111.

Next, the processor 110 acquires the plurality of physical property values of the samples (ST2). That is, in ST2, the processor 110 functions as the physical property value acquisition unit 113.

ST1 and ST2 may be steps of creating a database in which the measurement data and the physical property value are recorded in association with each sample. In this case, the execution order of ST1 and ST2 may be reversed. In addition, ST1 and ST2 may be executed in parallel.

Next, the processor 110 extracts the feature amount from the pieces of measurement data of the samples (ST3). That is, in ST3, the processor 110 functions as the feature amount extraction unit 112.

In ST3, the processor 110 may read out the measurement data designated by the user from the storage device 130. Then, the processor 110 may extract the feature amount by analyzing the measurement data read out from the storage device 130.

Next, the processor 110 acquires the feature amount set by the user (ST4). That is, in ST4, the processor 110 functions as the feature amount setting unit 114.

In ST4, the processor 110 may acquire the feature amount set by the user by receiving the editing of the image P11 from the user.

Next, the processor 110 estimates the physical property value of the simulated sample having the feature amount set by the user (ST5). That is, in ST5, the processor 110 functions as the physical property value estimation unit 115.

For example, in ST5, the processor 110 executes the regression analysis between the physical property value acquired in ST2 and the feature amount extracted in ST3. Then, the processor 110 estimates the physical property value of the simulated sample having the feature amount acquired in ST4 by referring to the correlation estimated as the result of the regression analysis.

Next, the processor 110 outputs the reconstruction data of the simulated sample having the feature amount set by the user (ST6). That is, in ST6, the processor 110 functions as the reconstruction data output unit 116.

More specifically, in ST6, the processor 110 outputs the reconstruction data based on the feature amount extracted in ST3 and the feature amount acquired in ST4.

Finally, the processor 110 displays, in the same screen, the image representing the magnitude of the feature amount set by the user, the image representing the magnitude of the estimated physical property value, and the image representing the reconstruction data (ST7). Then, the display system according to the present embodiment ends the series of operations. That is, in ST7, the processor 110 functions as the display controller 117.

In ST7, as shown in FIG. 4, the processor 110 displays the image P11 representing the magnitude of the feature amount set by the user, the image P12 representing the magnitude of the estimated physical property value, and the image P13 representing the reconstruction data in the same screen.

As described above, the display method according to the present embodiment displays the image representing the magnitude of the feature amount set by the user, the image representing the magnitude of the estimated physical property value, and the image representing the reconstruction data in the same screen.

With such a configuration, the display method according to the present embodiment can enable the user to more easily understand the correlation between the feature amount and the physical property value. In addition, with such a configuration, the display method according to the present embodiment can enable the user to more easily understand the correlation between the feature of the measurement data and the physical property value.

### Second Embodiment

### Configuration of Display System

Hereinafter, a second embodiment according to the present disclosure will be described in detail with reference to the drawings. In the following description, FIG. 4 will be appropriately referred to.

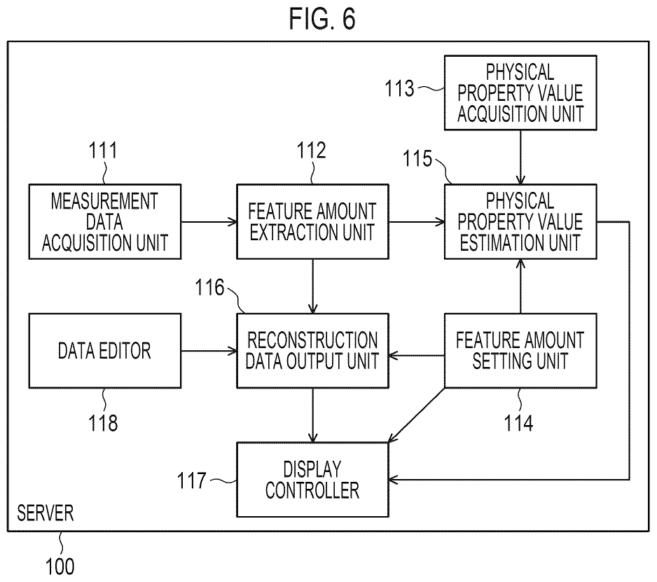

FIG. 6 is a block diagram showing a configuration of a display system according to the second embodiment. The display system according to the present embodiment is different from the display system according to the first embodiment in that the server 100 has a data editor 118 as a functional block.

The display system according to the present embodiment has the same configuration as the display system according to the first embodiment, except that the display system according to the present embodiment further has functions that will be described in detail below.

The data editor 118 receives the editing of the reconstruction data from the user. More specifically, the data editor 118 receives an editing operation of the image P13 shown in FIG. 4 from the user.

In the present embodiment, the user can execute various editing operations on the reconstruction data displayed as the image P13.
For example, in a case where the reconstruction data is the spectral data, examples of the editing operation that can be executed by the user include changes in a peak position, a peak width, a peak height, and the like.

In a case where the data editor 118 receives the editing of the reconstruction data from the user, the feature amount extraction unit 112 extracts the feature amount from the edited reconstruction data. The feature amount extraction unit 112 outputs the extracted feature amount to the feature amount setting unit 114.

The feature amount setting unit 114 receives the feature amount extracted from the edited reconstruction data as the feature amount set by the user. The feature amount setting unit 114 outputs the feature amount extracted from the edited reconstruction data to the physical property value estimation unit 115 and the display controller 117.

The physical property value estimation unit 115 acquires the feature amount extracted from the edited reconstruction data from the feature amount setting unit 114. The physical property value estimation unit 115 estimates the physical property value of the simulated sample having the feature amount extracted from the edited reconstruction data. The physical property value estimation unit 115 outputs the estimated physical property value to the display controller 117.

The display controller 117 displays an image representing the magnitude of the feature amount extracted from the edited reconstruction data as the image P11. In addition, the display controller 117 displays an image representing the magnitude of the physical property value of the simulated sample having the feature amount extracted from the edited reconstruction data as the image P12.

With such a configuration, the user can easily understand how the feature of the measurement data is reflected in the physical property value and the feature amount.

Further, the display controller 117 may display the image P11 and the image P12 to change in conjunction with the editing operation of the image P13 representing the reconstruction data.

With such a configuration, the user can further easily understand how the feature of the measurement data is reflected in the physical property value and the feature amount.

### Other Embodiment 1

Hereinafter, another embodiment according to the present disclosure will be described in detail with reference to the drawings. The display system according to the other embodiment 1 is a modification of the display system according to the first embodiment. More specifically, the display system according to the other embodiment is a modification of the display screen P1 of the display system according to the first embodiment.

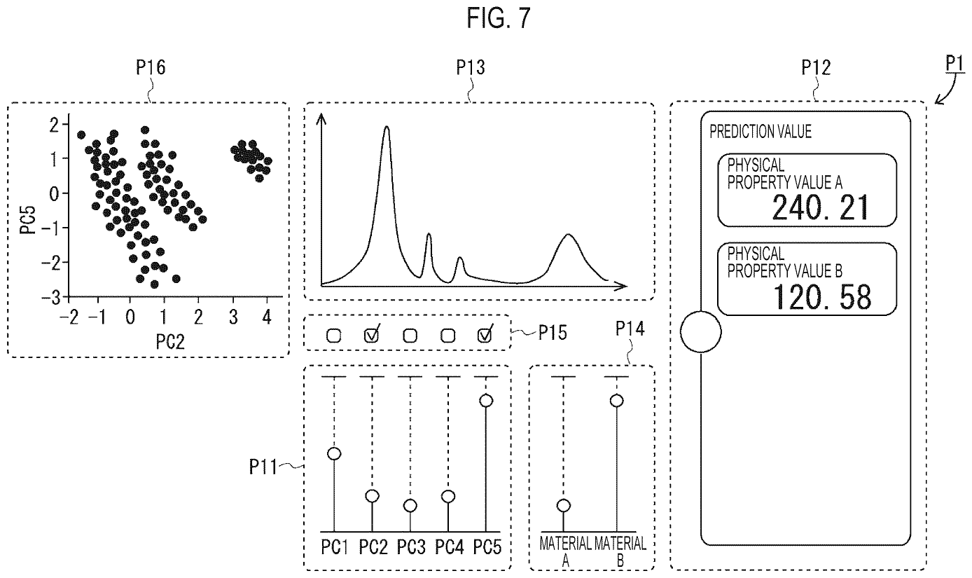

FIG. 7 is a schematic screen diagram showing a configuration of a display controller according to the other embodiment.

As shown in FIG. 7, the display controller 117 according to the other embodiment may display an image including a numerical value of the estimated physical property value as the image P12 representing the magnitude of the estimated physical property value.

In addition, the display controller 117 according to the other embodiment may display the image P12 representing the magnitude of the estimated physical property value in a switchable manner between a display state and a non-display state. For example, in FIG. 7, the image P12 may not be displayed by the user clicking a triangular button included in the image P12.

Further, the display controller 117 according to the other embodiment may display the image P13 in an enlarged manner in a case where the image P12 is in the non-display state.

In addition, the display controller 117 according to the other embodiment may further display an image P14 representing an experimental condition of the sample on the display screen P1.

As a specific example, in FIG. 7, an image indicating an amount of a material used for creating the sample is displayed as the image P14 representing the experimental condition of the sample.

Here, the image P14 representing the experimental condition of the sample may be displayed in an editable manner by the user. In a case where the image P14 representing the experimental condition of the sample is edited, the display system according to the other embodiment estimates the feature amount of the sample created by the edited experimental condition. Then, the display system according to the other embodiment reflects the estimated feature amount in the image P11.

In addition, the display system according to the other embodiment estimates the physical property value of the simulated sample having the estimated feature amount and simulates the measurement data of the simulated sample having the estimated feature amount. The display system according to the other embodiment reflects the estimation result of the physical property value in the image P12 and reflects the simulation result of the measurement data in the image P13.
The display system according to the other embodiment may display the image P11, the image P12, and the image P13 to change in conjunction with the editing operation of the image P14.
With such a configuration, the user can easily understand what influence the experimental condition of the sample has on the measurement data and the physical property value of the sample.
As a result, the user can further specifically formulate a guideline for developing a sample having a desired performance, and can perform the development activity more efficiently.

In addition, the display controller 117 according to the other embodiment may display a selection image P15 and a mapping image P16 on the display screen P1.

As shown in FIG. 7, the display controller 117 according to the other embodiment displays a plurality of bar images indicating the magnitudes of the feature amounts as the images representing the magnitudes of the feature amounts. Then, the selection image P15 for the user to select each feature amount is displayed in a vicinity of each bar image.
The selection image P15 is, for example, a check box image, and the user can select the feature amount by checking the check box image by the user operation. For example, in FIG. 7, the feature amount PC2 and the feature amount PC5 are selected.
The mapping image P16 is an image in which the pieces of measurement data are mapped with the feature amount selected by the selection image P15 as a graph axis. For example, the mapping image P16 in FIG. 7 is an image in which the measurement data is mapped with the feature amount PC2 and the feature amount PC5 as the graph axis.
With such a configuration, the user can more easily understand the correlation between the feature amounts.

### Other Embodiment 2

The display system according to the other embodiment 2 is an application example of the display system according to the first embodiment. The display system according to the other embodiment 2 is different from the first embodiment in that the display system further includes an outlier determination unit and a notification unit as functional blocks.

The outlier determination unit determines whether the set feature amount corresponds to an outlier in a data group consisting of the pieces of measurement data of the samples. The notification unit notifies the user of a warning in a case where the outlier determination unit determines that the set feature amount corresponds to the outlier.

With such a configuration, the user can determine whether the setting of the feature amount is appropriate.

Although the present disclosure has been described in detail with reference to the embodiments, the present disclosure is not only limited to the configurations of the embodiments. It is needless to say that various modifications, corrections, and combinations that can be made by those skilled in the art within the scope of the claims of the present patent application are included.

What is claimed is:

1. A display system comprising:
a physical property value estimation unit configured to estimate a physical property value of a simulated sample having a feature amount set by a user; and
a display controller configured to display, in the same screen, an image representing a magnitude of the feature amount set by the user and an image representing a magnitude of the estimated physical property value.

2. The display system according to claim 1, further comprising a reconstruction data output unit configured to output reconstruction data that is data obtained by simulating measurement data obtained in a case where the simulated sample is measured,
wherein the display controller is further configured to display an image representing the reconstruction data in the screen on which the image representing the magnitude of the feature amount set by the user and the image representing the magnitude of the estimated physical property value are displayed.

3. The display system according to claim 2, further comprising:
a data editor configured to receive editing of the reconstruction data from the user; and
a feature amount extraction unit configured to extract the feature amount from the edited reconstruction data,
wherein the physical property value estimation unit is configured to estimate the physical property value of the simulated sample having the feature amount extracted from the edited reconstruction data.

4. The display system according to claim 1, further comprising a measurement data acquisition unit configured to acquire a plurality of pieces of measurement data of samples,
wherein the display controller is
configured to display a selection image for the user to select each of the feature amounts in a vicinity of the image representing the magnitude of the feature amount, and
further configured to display, in the screen, a mapping image in which the acquired plurality of pieces of measurement data are mapped with a feature amount selected by the selection image as a graph axis.

5. The display system according to claim 1, further comprising:
a measurement data acquisition unit configured to acquire a plurality of pieces of measurement data of samples;
an outlier determination unit configured to determine whether the set feature amount corresponds to an outlier in a data group including the acquired plurality of pieces of measurement data of samples; and
a notification unit configured to notify the user of a warning in a case where the outlier determination unit determines that the set feature amount corresponds to the outlier.
